(19) United States
(12) Patent Application Publication
(10) Pub. No.: US 2019/0355485 A1
(43) Pub. Date: Nov. 21, 2019

(54) MICRO-FUSION-ENHANCED HYBRID PROPULSION FOR HIGH-ALTITUDE AIRCRAFT AND SPACE PLANES

(71) Applicant: Jerome Drexler, Los Altos Hills, CA (US)

(72) Inventor: Jerome Drexler, Los Altos Hills, CA (US)

(21) Appl. No.: 15/980,439

(22) Filed: May 15, 2018

(51) Int. Cl. G21B 3/00; G21B 1/11; B64D 27/02; B64G 1/14; B64G 1/40

(52) U.S. Cl. CPC G21B 3/004; G21B 1/11; B64D 2027/026; B64G 1/14; B64G 1/408; B64D 27/02

(57) ABSTRACT

A spaceplane and hybrid reaction engine employ micro-fusion enhanced propulsion in the presence of ambient cosmic rays and muons in the upper atmosphere at altitudes greater than 20 km. The reaction engines for the spaceplane may be of different types operable in different speed and altitude regimes, but at least one engine type incorporates a supply of deuterium-containing micro-fusion fuel that can be injected into the fuel mix along with the primary chemical fuel or into the exhaust in the nozzle section. The energetic fusion products from particle-target and/or muon-catalyzed fusion provide supplemental thrust for the spaceplane.

### TECHNICAL FIELD

The present invention relates to high-altitude aircraft (i.e., capable of achieving altitudes of at least 20 km or 65,000 feet) and aero-spacecraft (capable of both sustained and controlled flight in the atmosphere below 100 km altitude and flight in space above 100 km altitude and further capable of a soft touchdown), such as spaceplanes, and more particularly relates to systems and methods of propulsion of such craft. The invention also relates to inducement of controlled muon-catalyzed nuclear micro-fusion and particle-target micro-fusion to generate thrust-producing micro-fusion products.

### BACKGROUND ART

Most commercial aircraft today are propelled by two or more turbofan engines and have a cruising altitude between 35,000 and 42,000 feet (10.668 km and 12.802 km). This optimum altitude is a tradeoff between air resistance and oxygen availability, or alternatively between fuel efficiency and power. Fly higher and the atmosphere is thinner, producing less drag and higher cruising speeds, but also the oxygen level for efficiently powering the engines becomes sparser.

Higher altitude aircraft such as the Concorde SST cruised at 50,000-60,000 feet (approx. 15 to 18 km altitude), turbojet aircraft such as the Lockheed SR-71 and MiG-25M have set altitude records for their weight class of 25.929 km and 37.650 km, respectively. Even higher altitudes are potentially achievable by optimizing the engine for the much thinner oxygen levels (e.g. using scramjets) or by carrying at least some of their own oxidizer (as in rocket engines). A variety of experimental hypersonic aircraft and spaceplane prototypes are currently in development and testing. These would be capable, like airplanes, of taking off and landing at an airport, but also of achieving suborbital spaceflight or even reaching orbit. With their higher cruising speeds, substantially reducing transoceanic flight times (e.g. from New York to London or from Los Angeles to Tokyo) would have great appeal for many passengers, if costs could be contained.

Muon-catalyzed fusion was observed by chance in late 1956 by Luis Alvarez and colleagues during evaluation of liquid-hydrogen bubble chamber images as part of accelerator-based particle decay studies. These were rare proton-deuteron fusion events that only occurred because of the natural presence of a tiny amount of deuterium (about one part per 6400) in the liquid hydrogen. It was quickly recognized that fusion many orders of magnitude larger would occur with either pure deuterium or a deuterium-tritium mixture. However, John D. Jackson (Lawrence Berkeley Laboratory and Prof. Emeritus of Physics, Univ. of California, Berkeley) correctly noted that for useful power production there would need to be an energetically cheap way of producing muons. The energy expense of generating muons artificially in particle accelerators combined with their short lifetimes has limited its viability as an Earth-surface-based fusion source, since it falls short of break-even potential.

Another controlled fusion technique is particle-target fusion which comes from accelerating a particle to sufficient energy to overcome the Coulomb barrier and interact with target nuclei. To date, proposals in this area also depend upon using some kind of particle accelerator. Although some fusion events can be observed with as little as 10 KeV acceleration, fusion cross-sections are sufficiently low that accelerator-based particle-target fusion are inefficient and fall short of break-even potential.

It is known that cosmic rays are abundant in interplanetary space and to a lesser extent in Earth's upper atmosphere. Cosmic rays are mainly high-energy protons (with some high-energy helium nuclei as well) with kinetic energies in excess of 300 MeV. Most cosmic rays have GeV energy levels, although some extremely energetic ones can exceed 10¹⁸ eV. FIG. 6 shows cosmic ray flux distribution reaching the Earth's surface after significant absorption by Earth's atmosphere. In near-Earth space, the alpha magnetic spectrometer (AMS-02) instrument aboard the International Space Station since 2011 has recorded an average of 45 million fast cosmic ray particles daily (approx. 500 per second within that instrument's effective acceptance area and measurement energy range). The overall flux of galactic cosmic ray protons (above earth's atmosphere) can range from a minimum of 1200 m⁻²s⁻¹sr⁻¹ to as much as twice that amount. (The flux of galactic cosmic rays entering our solar system, while generally steady, has been observed to vary by a factor of about 2 over an 11-year cycle according to the magnetic strength of the heliosphere.) In regions that are outside of Earth's protective magnetic field (e.g. in interplanetary space), the cosmic ray flux is expected to be several orders of magnitude greater.

Cosmic rays are known to generate abundant muons from the decay of cosmic rays as they pass through Earth's atmosphere. Cosmic rays lose energy upon collisions with atmospheric dust, and to a lesser extent atoms or molecules, generating elementary particles, including pions and then muons, usually within a penetration distance of a few cm. Typically, hundreds of muons are generated per cosmic ray particle from successive collisions. Near sea level on Earth, the flux of muons generated by the cosmic rays' interaction by the atmosphere averages about 70 m⁻²s⁻¹sr⁻¹. The muon flux is even higher in the upper atmosphere. These relatively low flux levels near the Earth surface reflect the fact that both Earth's atmosphere and geomagnetic field substantially shields our planet from cosmic ray radiation.

### SUMMARY DISCLOSURE

The present invention provides for micro-fusion-enhancement of aeronautical flight at high (20 km or higher) altitudes and especially for aero-spaceflight, e.g. with spaceplanes, at altitudes that reach above 100 km. A hybrid micro-fusion-enhanced reaction engine incorporates one or more techniques of converting chemical fuel combustion into a directed energetic exhaust gas as a primary thrust source, especially at lower altitudes, and also incorporates a source of deuterium-containing micro-fusion fuel that reacts in the presence of ambient cosmic rays and muons to generate energetic fusion products that supplement the primary thrust. As cosmic ray and muon abundance increases with altitude, the micro-fusion supplemental thrust is available primarily at high altitudes, especially near the 100 km Kármán line.

The primary thrust is provided by any of several types of reaction engine, including air-breathing jet engines, as well as rocket engines having a separate oxidizer source. Jet engines can include turbofan, turbojet, ramjet, scramjet, pulse detonation engines. Spaceplanes may combine two or more different engine types for different altitudes and velocities, e.g. starting with turbofan propulsion from a ground start up to a 12 to 15 km cruising altitude at subsonic speeds then switching to some other type of propulsion, e.g. rocket propulsion. When an altitude is reached where cosmic rays and muons become sufficiently abundant, the deuterium-containing micro-fusion fuel may be added to the fuel mix to obtain supplemental thrust from energetic fusion products.

This aircraft or aero-spacecraft propulsion method takes advantage of the abundance of cosmic rays available for free and the abundance of muons generated from such cosmic rays in the Earth's upper atmosphere. Because the ambient cosmic rays and muons are available here for free in much larger quantities than at sea level, they do not need to be generated artificially in an accelerator. Since the amount of energy needed for thrust is generally much less than the multi-kiloton yields of atomic weapons, “micro-fusion” is the term used here to refer to fusion energy outputs of not more than 10 gigajoules per second (2.5 tons of TNT equivalent per second), to thereby exclude macro-fusion type explosions. The deuterium-containing micro-fusion fuel material as it released through the reaction chamber into the jet or rocket exhaust will interact with the incoming flux of cosmic rays and muons, thereby producing a combination of particle-target micro-fusion and/or muon-catalyzed micro-fusion. The cosmic ray particle or muon triggered micro-fusion events create a high velocity wind of alpha particles (helium nuclei) as fusion reaction products that can provide supplemental thrust.

The deuterium-containing “fuel” for the particle-target and/or muon-catalyzed micro-fusion is most conveniently supplied in the form of D₂ gas or liquid droplets in the same manner as normal hydrogen is already supplied to any of the various hydrogen-fueled reaction engines. Muon-created muonic deuterium can come much closer to the nucleus of a neighboring atom with a probability of fusing the nuclei, releasing energy. Once a muonic molecule is formed, fusion proceeds extremely rapidly (˜10⁻¹⁰ sec). One cosmic ray particle can generate hundreds of muons, and each muon can typically catalyze about 100 micro-fusion reactions before it decays (the exact number depending on the muon “sticking” cross-section to any helium fusion products).

Alternatively, heavy water (D₂O) or even solid Li⁶D as chips, pellets or powder (preferably encapsulated to prevent chemical reaction during storage). For example, a desired reaction is Li⁶+D→2He⁴+22.4 MeV, where much of the useful excess energy is carried as kinetic energy of the two helium nuclei (alpha particles). Additionally, any remaining cosmic rays can themselves directly stimulate a micro-fusion event by particle-target fusion, wherein the high energy cosmic ray particles (mostly protons, but also helium nuclei) bombard relatively stationary target material. When bombarded directly with cosmic rays, the lithium-6 may be transmuted into tritium which could form the basis for some D-T micro-fusion reactions.

It should be noted that the quantity of micro-fusion fuel reactions is extremely small (on the order of 10¹² reactions per second for each watt of output) and the corresponding amount of micro-fusion fuel consumed is likewise small (estimated on the order of micrograms of fuel per watt, depending on the fusion cross-section). This is much smaller than the chemical fuel needs. The ambient flux of cosmic rays and generated muons are already naturally present in the upper atmosphere. The optimum concentration of the target material for the particle-target and muon-catalyzed micro-fusion may be determined experimentally based on the abundance of cosmic rays with a view to maintaining the trillions of micro-fusion events at a rate adequate for generating the desired thrust, while avoiding any possibility of a runaway macro-fusion event.

At a minimum, since both particle-target micro-fusion and muon-catalyzed micro-fusion, while recognized, are still experimentally immature technologies (since measurements have only been conducted to date on Earth using artificially accelerated particles and generated muons from particle accelerators), various embodiments of the present invention can have research utility to demonstrate feasibility of achieving adequate thrust in Earth's upper atmosphere and near space environment for trial purposes, in order to determine optimum parameters. For example, the actual number of micro-fusion reactions for various types of fusion fuel sources and target configurations, and the amount of thrust that can be derived from such reactions and their fusion products, are still unknown and need to be fully quantified to improve the technology.

### BRIEF DESCRIPTION OF THE DRAWINGS

FIG. 1 is a schematic perspective view of a spaceplane using cosmic-ray/muon-catalyzed micro-fusion propulsion as a supplemental thrust source at high altitudes.

FIG. 2 is a representative flight profile illustrating different thrust sources for different altitudes in a spaceplane flight.

FIG. 3 is a sectional view of a typical turbojet engine, but that incorporates a supplemental source of deuterium-containing micro-fusion fuel that can be injected into the chemical fuel mixture.

FIG. 4 is a sectional view of a typical scramjet engine that likewise incorporates a supplemental source of deuterium-containing micro-fusion fuel that can be injected into the chemical fuel mixture.

FIG. 5 is a sectional view of a typical rocket engine that can employ deuterium-enriched hydrogen fuel.

FIG. 6 is a graph of cosmic ray flux at the Earth surface versus cosmic ray energy, after very significant cosmic ray absorption by Earth's atmosphere has occurred.

### DETAILED DESCRIPTION

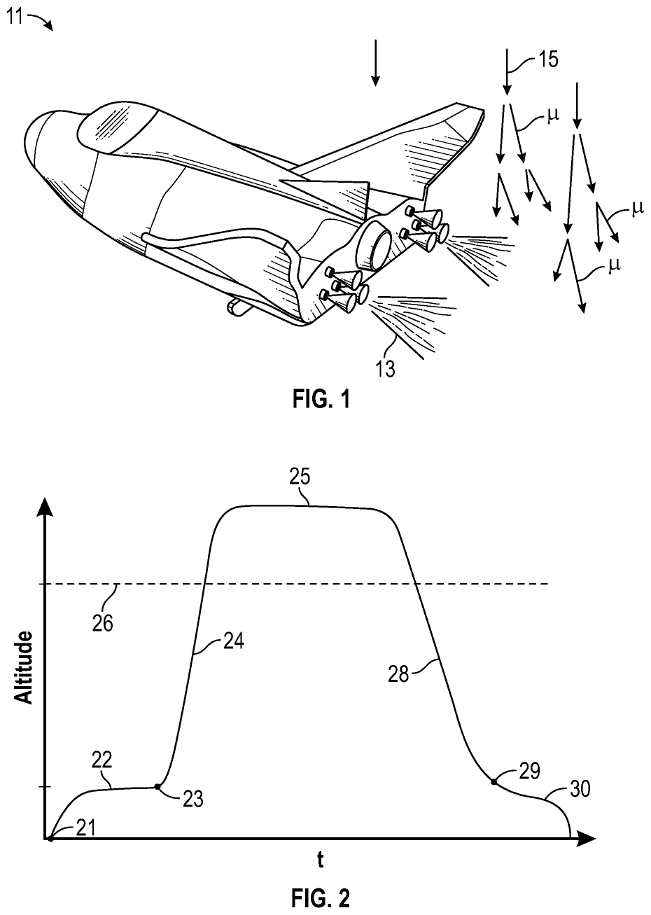

With reference to FIG. 1, a spaceplane 11 climbing in the upper atmosphere is seen. Directed out the back of one or more reaction engines is a jet of exhaust gas 13 containing an added micro-fusion fuel. This deuterium-containing micro-fusion fuel material is preferably added to the reaction engine fuel mix only when the ambient flux 15 of cosmic rays and muons (μ) outside the craft is sufficiently abundant to facilitate micro-fusion events. The cosmic rays and muons interact with the micro-fusion fuel to facilitate particle-target type micro-fusion and muon-catalyzed micro-fusion respectively and create energetic reaction products, e.g. alpha (α) particles. These reaction products also interact with the engine and/or the craft to generate supplemental thrust. The exact altitude above which such conditions apply is an experimental parameter but is at least above about 20 km altitude. Such flux increases with altitude up to and above 100 km altitude. (The 100 km altitude Kármán line is a conventional definition of Earth's atmosphere-space “boundary”; it is where aerodynamic lift and centrifugal force balance. Below this altitude, aerodynamic lift dominates and is the realm of aeronautics, whereas higher altitudes are the realm of astronautics where centrifugal force is the dominant effect keeping a spacecraft aloft. One alternative atmosphere-space boundary convention uses atmospheric drag as its criterion, wherein above 150 km altitude circular orbits can be sustained without propulsion.)

A variety of different reaction engine types exist that can readily be modified to incorporate the present invention's supplemental micro-fusion thrust. It is merely a matter of introducing a very small amount deuterium-containing micro-fusion material (e.g. D₂, D₂O or Li⁶D) into the fuel mix. A reaction engine discharges a fast-moving jet that generates thrust to propel the craft forward. The reaction engine is any of a rocket engine, liquid air-cycle engine, pulse detonation engine, pulsejet, scramjet, ramjet, turbojet, or even turbofan engine. Among these are several kinds of jet engines. A turbojet engine compresses air with an inlet and fan compressor, then mixes fuel with the compressed air, burning the mixture in a combustor, and passes the hot, high-pressure exhaust through a turbine and nozzle. The turbine powers the compressor. A turbofan engine differs in that an additional large fan at the front of the engine accelerates air in a duct that bypasses the core gas turbine engine. This provides greater thrust and is more efficient at lower speeds. It is available in both efficient high-bypass designs for most commercial aircraft and low-bypass designs for supersonic flight. Ram-powered engines (ramjets and scramjets) rely only on air compressed through the input, rather than axial or centrifugal fan compressors, and contain no moving parts. They are highly efficient at supersonic speeds, but cannot operate at a standstill, so some other engine type must be employed to reach the speeds where the ram-powered engine can started. Scramjets differ from ramjets in that scramjets do not slow the airflow to subsonic speeds for combustion. Pulse detonation engines use detonation rather than deflagration as its form of combustion. The air is compressed and the air-fuel mixture is combusted intermittently instead of continuously, e.g. by use of valves. Rocket engines carry at least some of their own oxidizer so can operate where the atmosphere is too thin for other forms of jet propulsion.

As seen in FIG. 2, a typical flight profile for a spaceplane. For example, starting from a standstill, a turbofan or turbojet engine may be used from the ground 21 up to a first altitude 23 (e.g. 12 to 15 km for turbofan engines, up to 25 or even 30 km for turbojet engines). This is the jet-powered phase 22. Once this first altitude 23 is reached, the turbofan or turbojet engine is turned off and a different engine type, such as a scramjet or rocket engine, is activated to reach space (above 100 km) in either suborbital or orbital flight 25. This is the high-altitude climb phase 24. In either case, at high altitudes, e.g. above 20 km, the primary jet propulsion from chemical combustion is supplemented in the present invention by adding micro-fusion fuel to the mix. In the presence of sufficient ambient cosmic rays and muons enough fusion events will be catalyzed to provide supplemental thrust. At some very high altitude at or near the 100 km Kármán line 26, it is possible that the fusion-generated thrust alone might be sufficient to propel the craft. The spaceplane may reenter Earth's atmosphere in a glide mode 28, such as was used by the NASA space shuttle, but once a low altitude for turbofan or turbojet engine operation is reached 29, the jet engines may be reengaged for powered landing 30 at an airport.

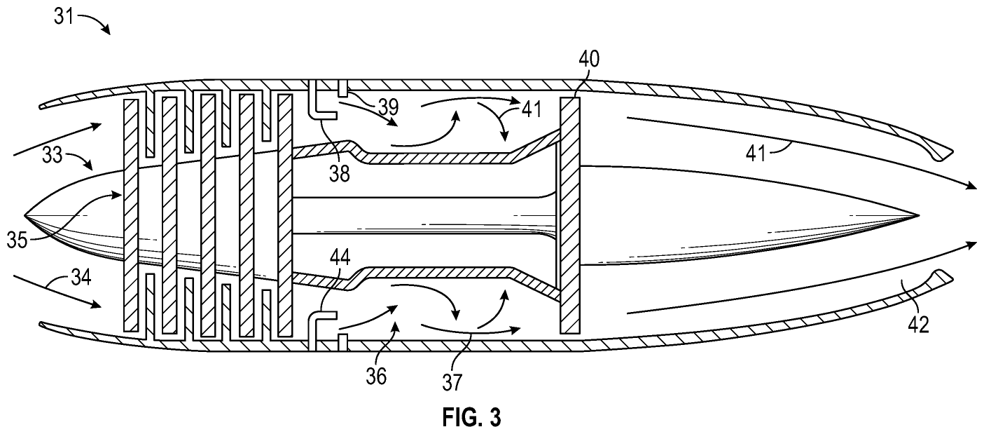

With reference to FIG. 3, a typical turbojet engine 31 is seen. It is modified in the present invention by allowing for the selected introduction of deuterium-containing micro-fusion fuel to the chemical fuel mix. At the front (left-side in the view) of the engine is the air intake 33 in which atmospheric air 34 is fed to a series of low-pressure and then high-pressure compressor fans 35. A diffuser (not shown) may be provided to slow down the air delivered by the compressor to the combustor 36 for better efficiency. Fuel droplets 37 sprayed into the combustor 36 through a fuel inlet 38 mix with the compressed air and is ignited, e.g. by an external igniter 39. Fuel is burned continuously and produces hot combustion products 41 that drive a turbine 40 and exit as an exhaust jet through a nozzle 42. The turbine 40 drives the compressor 35. For micro-fusion supplemented thrust, a small amount of deuterium-containing micro-fusion fuel is introduced, preferably with the chemical fuel at the fuel inlet 38, but alternatively with its own inlet 44 either into the combustor 36 or even beyond the turbine 40 in the nozzle section 42. The small amount of micro-fusion fuel reacts with ambient cosmic ray and muons to generate energetic fusion products that provide supplemental thrust. Turbofan engines can be modified in a similar manner and differ only in having a large front fan and an accelerated air bypass surrounding a turbo-jet-type core.

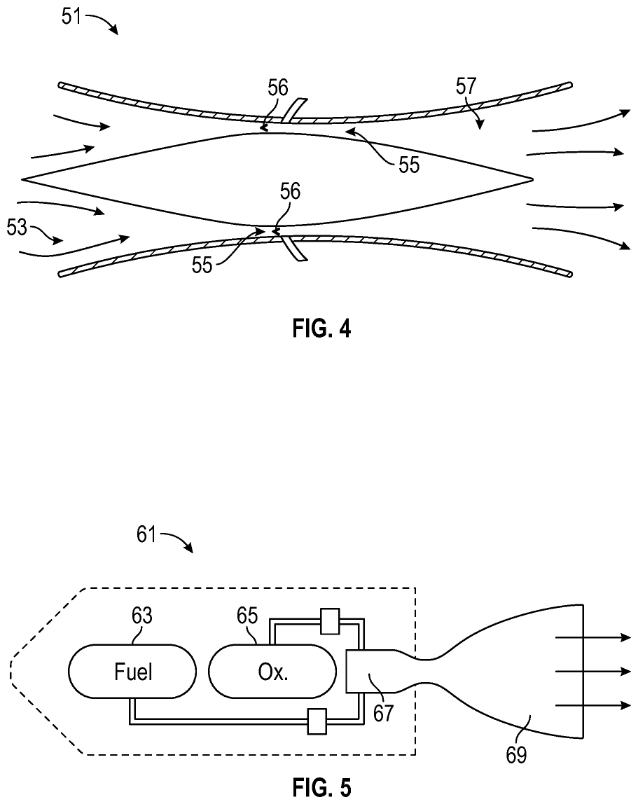

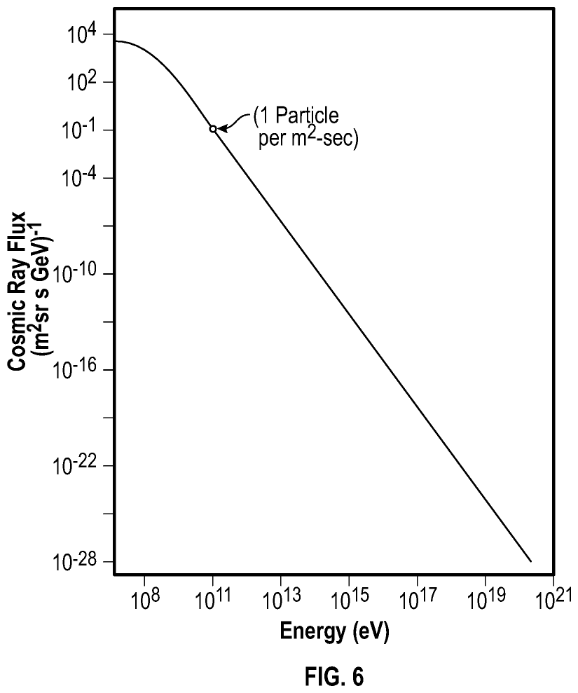

FIG. 4 illustrates a typical scramjet engine 51 that can be modified for micro-fusion supplemented thrust. The scramjet 51 has no moving parts (no rotating fan compressor or turbine) and instead relies on an already high-speed craft to compress incoming air forcefully before combustion. A spaceplane equipped with such an engine would need either a mother plane to carry it to the first altitude and at the requisite speed, then release the plane so that the scramjet can be activated. The intake 53 is shaped with a progressively narrowing area to ram air through the inlet diffuser to the combustion region 55 (the narrowest area), where fuel is sprayed into the compressed air. There is no downstream turbine, but rather the combustion products are accelerated through a divergent nozzle 57 as a jet exhaust. The temperature of the compressed air may be sufficient for self-ignition of the fuel spray, or an external ignitor may be provided. Because of the supersonic air speeds in the combustor 55, flame holders 56 may be provided, as well as pyrophoric fuel additives, to prevent flameout. Once again, in the present invention the same or a separate fuel inlet may supply the micro-fusion fuel to the mix. The micro-fusion fuel may be introduced either in the combustor region 55 or in the nozzle region 57.

With reference to FIG. 5, a rocket engine 61 may include deuterium-containing micro-fusion fuel as part of its fuel mix 63. For example, in rocket engine employing liquid hydrogen as its fuel, the hydrogen could be enriched with a greater abundance of deuterium. Fuel 63 and oxidizer 65 are pumped into the reaction chamber 67. Alternatively, grains of Li⁶D could be incorporated into solid rocket fuel. The thrust from the chemical rocket ignition products exiting through the nozzle 69 also propels the micro-fusion fuel which interacts with the ambient cosmic rays and muons to produce energetic fusion products that supplement the thrust.

The fuel can be solid Li⁶D in powder form, D-D or D-T inertial-confinement-fusion-type pellets, or D₂O ice crystals, or droplets of (initially liquid) D₂. Stored fuel will be shielded to reduce or eliminate premature micro-fusion events until delivered to the engines for thrusting. One need not eliminate cosmic rays or their secondary particles (pions, muons, etc.) to zero, but merely reduce their numbers and energies sufficiently to keep them from catalyzing large numbers of micro-fusion events in the stored target particle material. Additionally, since the use of micro-fusion fuel is expected to reduce the required amount of chemical rocket propellant by about a factor of two, one can easily afford the extra weight of some small amount of metal for shielding, if needed. (For example, the Juno unmanned spacecraft to Jupiter contains radiation vaults of 1 cm thick titanium to shield its electronics from external radiation. A similar type of vault might be used in this case for shielding the stored micro-fusion fuel.)

The micro-fusion target material will be exposed to ambient cosmic rays and muons (μ). As cosmic rays collide with micro-fusion target material, they form muons μ that are captured by the deuterium and that catalyze fusion. Likewise, the cosmic ray collisions themselves can directly trigger particle-target micro-fusion. Various types of micro-fusion reactions may also occur, such as Li⁶-D reactions, generally from direct cosmic ray collisions, as well as D-T, using tritium generated by cosmic rays 15 impacting the lithium-6. D-T reactions especially may be assisted by muon-catalyzed fusion. The volume of the continuous slow fusion creates high velocity fusion products (fast alpha particles or helium “wind”, etc.) that bombard the engine nozzle surfaces. The energetic alpha particle micro-fusion products (α) provide thrust for the craft. If the engine is part of the craft's tail section, a large-diameter, but aerodynamic disc or pressure plate, like that conceived for the Orion project, could be mounted on the craft 11 to receive additional fusion products α to maximize the thrust obtained.

The amount of energy generated by the micro-fusion reactions, and the thrust the micro-fusion products produce, depends upon the quantity of fuel released and the quantity of available cosmic rays and muons in the ambient environment surrounding the craft. Assuming most of the energy can be captured and made available for thrust, an estimated 10¹⁵ individual micro-fusion reactions (less than 1 μg of fuel consumed) per second would be required for 1 kW output. But as each cosmic ray can create hundreds of muons and each muon can catalyze about 100 reactions, the available cosmic ray flux in the upper atmosphere is believed to be sufficient for this thrust purpose following research, development, and engineering efforts.

1. A micro-fusion-enhanced hybrid engine for high-altitude powered airplanes and reusable aero-spacecraft, comprising:
a reaction engine having a combustor region and a nozzle converting a chemical fuel via combustion into a directed energetic exhaust gas for providing primary thrust;
a source of deuterium-containing micro-fusion fuel that is reactable in the presence of ambient cosmic rays and muons to generate energetic fusion products for providing supplemental thrust.

2. The hybrid engine as in claim 1, wherein the reaction engine is any of a rocket engine, liquid air-cycle engine, pulse detonation engine, pulsejet, scramjet, ramjet, turbojet, or turbofan engine.

3. The hybrid engine as in claim 1, wherein the micro-fusion fuel is introduced into the combustor region.

4. The hybrid engine as in claim 1, wherein the micro-fusion fuel is introduced into the nozzle.

5. The propulsion system as in claim 1, wherein the deuterium-containing particle fuel material comprises D₂.

6. The propulsion system as in claim 1, wherein the deuterium-containing particle fuel material comprises D₂O.

7. The propulsion system as in claim 1, wherein the deuterium-containing particle fuel material comprises Li⁶D.

8. The propulsion system as in claim 1, wherein the deuterium-containing particle fuel material is in liquid droplet form.

9. The propulsion system as in claim 1, wherein the deuterium-containing particle fuel material is in solid powder form.

10. The propulsion system as in claim 1, wherein energetic fusion products are generated in the reaction engine and react against the nozzle.

11. A spaceplane with micro-fusion-assisted propulsion in the presence of an ambient flux of cosmic rays and muons, comprising:
a fuselage having aerodynamic flight surfaces;
at least one reaction engines attached to at least one of the fuselage and flight surfaces, the reaction engine having a combustor region and a nozzle converting a chemical fuel via combustion into a directed energetic exhaust gas for providing primary thrust;
a source of deuterium-containing micro-fusion fuel that is reactable in the presence of ambient cosmic rays and muons to generate energetic fusion products for providing supplemental thrust to the spaceplane.

12. The spaceplane as in claim 11, wherein the micro-fusion fuel is introduced into the combustor region of the reaction engine.

13. The spaceplane as in claim 11, wherein the micro-fusion fuel is introduced into the nozzle of the reaction engine.

14. The spaceplane as in claim 11, wherein the reaction engine is any of a rocket engine, liquid air-cycle engine, pulse detonation engine, pulsejet, scramjet, ramjet, turbojet, or turbofan engine.

15. The spaceplane as in claim 11, wherein two or more reaction engines of two or more different types are attached to the fuselage and flight surfaces, one type operable at subsonic speeds and altitudes less than 20 km, and at least one other type operable at supersonic or hypersonic speeds and at altitudes greater than 20 km.

16. The spaceplane as in claim 11, wherein the deuterium-containing particle fuel material comprises D₂.

17. The spaceplane as in claim 11, wherein the deuterium-containing particle fuel material comprises D₂O.

18. The spaceplane as in claim 11, wherein the deuterium-containing particle fuel material comprises Li⁶D.

19. The spaceplane as in claim 11, wherein the deuterium-containing particle fuel material is in liquid droplet form.

20. The spaceplane as in claim 11, wherein the deuterium-containing particle fuel material is in solid powder form.
